(19) United States
(12) Patent Application Publication
(10) Pub. No.: US 2010/0071797 A1
(43) Pub. Date: Mar. 25, 2010

(54) FIRE RETARDANT AIR HANDLING SYSTEM DUCTWORK COMPONENT AND METHOD OF MANUFACTURE

(76) Inventor: Jon W. Jungers, Rogers, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/567,457

(22) Filed: Sep. 25, 2009

Related U.S. Application Data
(60) Provisional application No. 61/100,171, filed on Sep. 25, 2008.

(51) Int. Cl. F16L 9/14

(52) U.S. Cl. 138/141; 138/149

(57) ABSTRACT

A rigid ductwork component for a residential, commercial, or industrial air handling system that is comprised of a rigid, tubular, fire retardant layer including a foamed or non-foamed polymer resin and a fire retardant compound. In some embodiments, the ductwork component satisfies the requirements of UL E-84 rating, and the fire retardant compound includes nanoparticles.

### CROSS-REFERENCE TO RELATED APPLICATIONS

This application claims priority under 35 U.S.C. §119(e)(1) to U.S. Provisional Patent Application Ser. No. 61/100,171, filed Sep. 25, 2008, entitled “Fire Retardant Air Handling System Ductwork Component and Method of Manufacture”, and bearing Attorney Docket No. J244.103.101; and the entire teachings of which are incorporated herein by reference.

### BACKGROUND

The present disclosure relates to rigid ductwork components for air handling systems such as residential, commercial, or industrial heating, ventilating, and air conditioning (HVAC) systems. More particularly, it relates to an integrally formed, polymer-based air handling system ductwork component(s) with fire retardant properties.

Residential, commercial, and industrial air handling systems include various ductwork components used to direct heated, cooled, filtered, and/or contaminated air from a source to one or more rooms, a treatment unit, or the ambient environment. For example, the air handling system can include a heating system (e.g., furnace, heat pump, electrical heat, etc.), cooling system (e.g., air conditioner), and/or a filtering system. Various ductwork components are also employed and direct the air (typically via fan(s) or blower(s)) to the desired end location. The ductwork components can include one or more of a plenum, hot air take-offs, ducts, pipes, boots, wallstacks, registers, tees, reducers, etc. (hereinafter collectively referred to as “ductwork components”). These ductwork components are traditionally formed of metal; more particularly, galvanized stainless steel or sheet metal. While well accepted, stainless steel or sheet metal ductwork components are characterized by a number of potential drawbacks.

For example, metal ductwork components are not energy efficient, due largely to poor thermal insulative properties and significant air leakages at joints. Further, difficulties are often encountered when joining two separate ductwork components to one another due to variations in size. Also, though galvanized stainless steel is quite robust, deterioration or rupturing will inevitably occur over time due in large part to corrosion.

Efforts have been made to address some of the above-identified concerns. For example, a separate layer of insulation is often wrapped around pipe ductwork components to minimize undesirable heat transfer. More recently, plastic or polymer-based ductwork components have been developed, for example as described in U.S. application Ser. No. 11/930,984 entitled “Air Handling System Ductwork Component and Method of Manufacture” the teachings of which are incorporated herein by reference. In this regard, plastic-based ductwork components appear highly viable, and may revolutionize the HVAC industry. A point of concern, however, is performance of the plastic ductwork components (as well as “standard” metal-based components) in the presence of flames. In particular, many countries, such as the United States, have standardized building codes in place that set forth fire retardant ratings that must be met by the ductwork components. While a plastic-based ductwork component could be separately wrapped in a fire retardant material, this technique is labor-intensive, entails additional costs, and does not address the interior ductwork surface.

In light of the above, a need exists for polymer or plastic-based ductwork components satisfying fire retardant code requirements, as well as related methods of manufacture.

### SUMMARY

Some aspects in accordance with principles of the present disclosure relate to a rigid ductwork component for a residential, commercial, or industrial air handling system that is comprised of a rigid, tubular, fire retardant layer including a foamed or non-foamed polymer resin and a fire retardant compound. In some embodiments, the ductwork component satisfies the requirements of UL E-84 rating, and the fire retardant compound includes nanoparticles.

### BRIEF DESCRIPTION OF THE DRAWINGS

FIG. 1 is a longitudinal cross-sectional view of a ductwork component in accordance with the present disclosure;

FIG. 2A is a transverse, cross-sectional view of the ductwork component of FIG. 1;

FIG. 2B is a transverse, cross-sectional view of another ductwork component in accordance with the present disclosure;

FIG. 2C is a transverse, cross-sectional view of another ductwork component in accordance with the present disclosure; and

FIG. 3 is an exploded view of an HVAC air handling system including ductwork components in accordance with the present disclosure.

### DETAILED DESCRIPTION

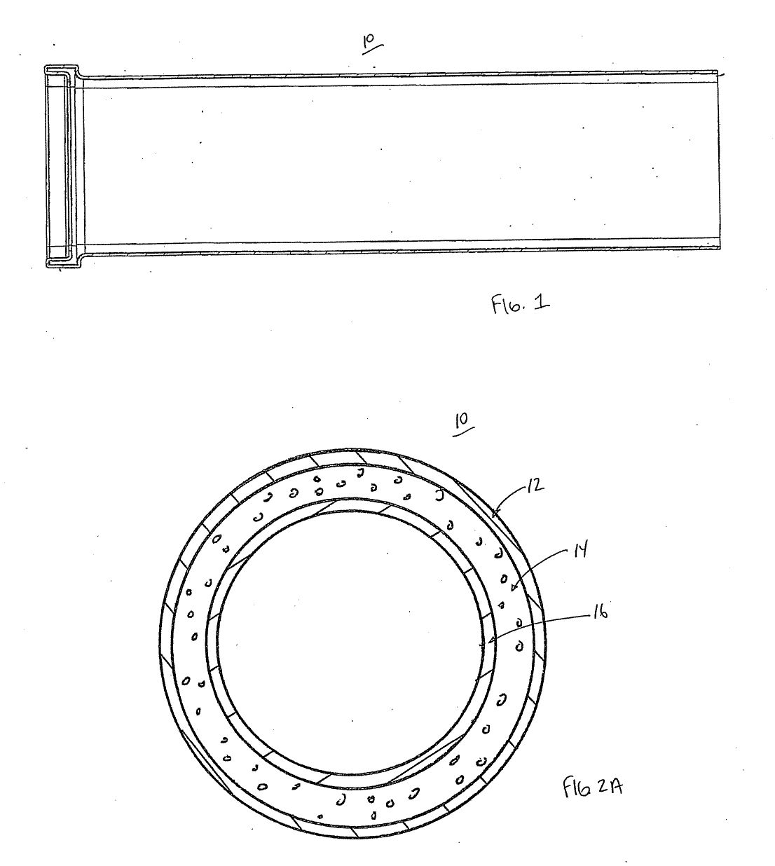

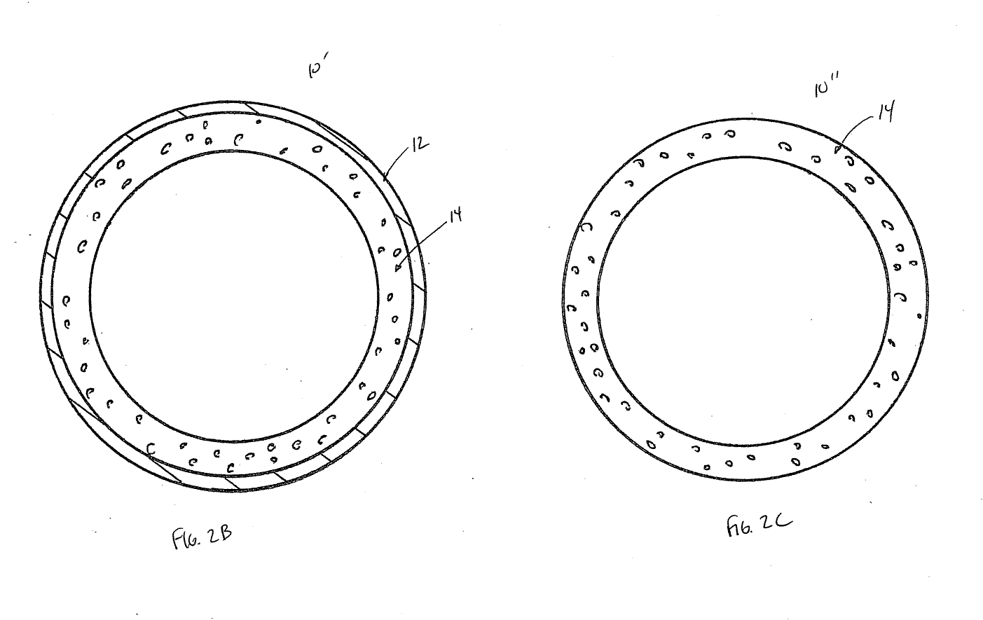

One embodiment of a rigid, ductwork component 10 in accordance with the present disclosure is shown in FIG. 1 in the form of an air duct. In terms of overall size and shape, the air duct 10 replicates ducts commonly employed in residential, commercial, or industrial air handling system applications, and thus can be straight or curved. Alternatively, the ductwork component 10 can assume a form or shape useful for virtually any component of an air handling system. Regardless, and as shown in greater detail in FIG. 2A, the ductwork component 10 includes an outer layer 12, an intermediate layer 14, and an inner layer 16. In general terms, the outer and inner layers 12, 16 are a molded polymer, whereas the intermediate layer 14 includes a molded fire retardant material. With this construction, the layers 12-16 are bonded to one another, with the intermediate layer 14 providing sufficient rigidity to fully support the ductwork component 10 within an air handling system, and providing a fire retardant property, for example commensurate with UL E-84 rating (e.g., the ductwork component 10 qualifies as a Class I air duct).

The outer and inner layers 12, 16 can be identical in terms of composition and thickness and serve to encapsulate or protect the intermediate layer 14. While the outer and inner layers 12, 16 can be formed of various materials, plastic or polymer is preferably employed. For example, in some embodiments the outer and inner layers 12, 16 are 5-10 mil polyethylene. Other plastic materials (or combination of plastic materials) selected to encapsulate the fire retardant intermediate layer 14 are also envisioned and/or the inner layers 12, 16 can have a greater or lesser thickness. Further, although the outer and inner layers 12, 16 are depicted in FIG. 2A as being defined by a clear demarcation line, depending upon the particular manufacturing technique employed (e.g., rotational molding), a gradual transition from the intermediate layer 14 to one or both of the outer and/or inner layers 12, 16 can occur with the present disclosure. Regardless, the outer and inner layers 12, 16 do not include a metal, and exhibit one or more enhanced properties as compared to the intermediate layer 14. For example, at least the inner layer 16 (and optionally the outer layer 12) is formed to be abrasion resistant and/or smooth, thus presenting minimal frictional loss to the air stream passing through the component 10. Additionally or alternatively, one or both of the outer and inner layers 12, 16 are formed to be more moisture and chemical resistant (as compared to the intermediate layer 14) to reduce the opportunities of undesired reaction of external air (and corresponding moisture/humidity) or the air stream with flame retardant component(s) of the intermediate layer 14. In more general terms, then, the outer and inner layer 12, 16 are formed to encapsulate the intermediate layer 14, and thus the flame retardant and smoke suppressant components associated therewith, from the environment, and vice-versa.

The intermediate layer 14 is compounded and formed to incorporate a smoke suppression and fire retardant material, such as fire retardant material(s) in the form of nanoparticles. Nanoparticles are defined as any particle having at least one dimension in the nanometer range which enhances the properties of a matrix polymer when dispersed throughout. With this in mind, the fire retardant compound(s) associated with the intermediate layer 14 are preferably extrusion grade particles or pellets or nanoparticle-based coatings or penetrants that exhibit elevated resistance to smoke and flame. For example, the fire retardant material can be a non-halogenated fire retardant material commonly employed for fire suppression. Alternatively, the fire retardant material can be a magnesium hydroxide-based or aluminum trihydrate-based fire retardant material. Other fire retardant compounds are also contemplated, such as those that decompose endothermically when heated.

To enhance dispersion of the fire retardant components (e.g., nanoparticles) within the intermediate layer 14, the intermediate layer 14 further includes polymer matrix components, for example a polyolefin. For example, polyethylene such as linear low-density polyethylene (LLDPE), high-density polyethylene (HDPE), low-density polyethylene (LDPE), etc., can be employed. Even further, other plastic resins, such as other polyolefins, ethylene-vinyl acetate, polyvinyl chloride, polyester, Nylon®, polycarbonate, polyurethane, etc., are also acceptable. Regardless, a flow additive is incorporated into the fire retardant material/polyolefin resin compound to render the fire retardant material (e.g., magnesium oxide) flowable for subsequent molding.

As indicated above, the fire retardant intermediate layer 14 can be formed as part of a plastic extrusion or molding process. In some embodiments, then, the extrudable fire retardant component(s) are compounded with a polymer resin at a ratio of 50%-65% fire retardant and smoke suppression components: 35%-50% polyethylene (or other plastic resin(s) or recycled plastic material(s)). In yet other embodiments, the intermediate layer 14 is foamed plastic, with the fire retardant component(s) and polymer or polyolefin resin being compounded with a foaming agent, such as an activated azodicarbonamide. When heated during the molding process, the foaming agent generates a gas that is trapped inside the molten plastic and causes it to foam. The resultant structure then has porous walls that are stiffer but lighter in weight than a solid wall of the same strength. For example, in some embodiments the intermediate layer 14 has a foamed construction and a thickness in the range of 0.020 inch-0.290 inch, alternatively in the range of 0.120 inch-0.190 inch. Alternatively, the intermediate layer 14 can be a non-foamed plastic (with fire retardant/smoke suppressant components(s)), and/or can have a greater or lesser thickness.

In some embodiments, the ductwork component 10 is formed via an extrusion process in which the layers 12-16 are simultaneously extruded and thus bonded to one another. Following extrusion, the inner and outer layers 12, 16 encapsulate the fire retardant intermediate layer 14, thereby eliminating possible erosion or “leaching” of the fire retardant material. By way of example, ductwork components utilizing the above materials and extrusion molding have been produced and have achieved a UL E-84 rating, qualifying as a Class I air duct.

Although the ductwork component 10 has been described as being formed by a plastic extrusion process, other manufacturing techniques common to the plastic manufacturing art can be employed. For example, the ductwork component 10 can be formed by rotational molding, injection molding, blow molding, laminating the layers 12-16 to one another, etc.

Formulation of the molding compound can further include other additives that enhance certain characteristics of the resulting ductwork component. For example, the plastic and foaming agent (where provided) components can be selected to provide the fire retardant intermediate layer 14 with an elevated R value for enhanced insulative effects and thus be highly useful for extreme temperature applications (e.g., attic or crawl space). The insulative properties of the ductwork component 10 can be further enhanced by applying one or more additional insulative layers to the exterior (i.e., over the outer layer 12) and/or interior (i.e., inside of the inner layer 16) as desired. For example, an R8 insulation material can be wrapped about the outer layer 12. Alternatively, a polyurethane foam with an aluminum Mylar sleeve (or any other sleeve) can be applied over the outer layer 12.

Also, a desired colorant or pigment additive can be used to produce a desired exterior color for the ductwork component 10. Any heat stable and un-reactive colorants known and available for use with the selected plastic resin (and foaming agent where provided) can be provided. Illustrative examples of useful colorants include carbon black, quinaeridone red, anthraquinone, and perinone dyes to name but a few. The resulting ductwork component 10 can thus be virtually any color, such as black, red, yellow, brown, blue, etc. Other optional additives include fillers, tackifying agents, dispersing agents, UV stabilizers, antioxidants, char formation supplements, coupling agents, and/or melt-flow enhancers.

An alternative construction of a ductwork component 10′ is shown in FIG. 2B, and consists of the outer layer 12 and the fire retardant intermediate layer 14. The layers 12, 14 can be highly similar to those described above, with the outer layer 12 serving as a polyethylene skin (thickness on the order of 5-10 mil), and the fire retardant intermediate layer 14 providing requisite structural rigidity and fire retardance/smoke suppression (e.g., thickness on the order of 120 mil-190 mil, + or −10 mil).

Yet another alternative construction for the ductwork component 10″ is shown in FIG. 2C and consists solely of the fire retardant layer 14. With this configuration, the layer 14 is identical to the intermediate layer 14 as described above, with the foamed (or non-foamed) polymer resin integrated with and/or encapsulating and/or sealing the fire retardant/smoke suppressant component(s).

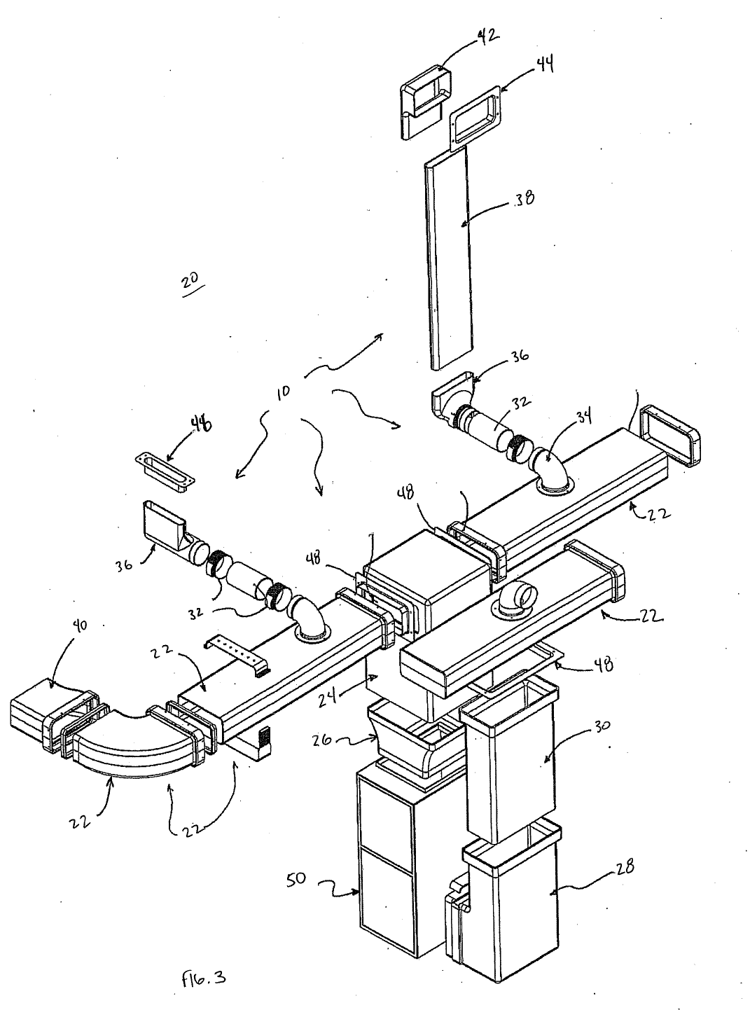

The ductwork component 10 as described above can assume a wide variety of forms or shapes useful in an air handling system 20 as shown in FIG. 3. As a point of reference, the air handling system 20 of FIG. 3 reflects but one of a multitude of possible configurations with which the present disclosure is useful. That is to say, air handling systems, such as the system 20 of FIG. 3, are designed to satisfy the needs of the particular residential, commercial, or industrial installation in question. Thus, depending upon the particular installation requirements, additional ones of the ductwork component 10 identified in FIG. 3 may be included and/or other of the ductwork components 10 eliminated. However, at least one of the ductwork components 10, preferably all of the ductwork components 10, of the particular system 20 installation is an integrally formed, plastic-based body satisfying UL fire retardant/smoke suppression requirements and providing requisite structural strength and airflow handling capabilities. For example, the ductwork components 10 can be one or more of an airflow duct 22, a hot air plenum 24 (with or without a hot air take-off 26), a cold air plenum/take-off 28, a cold air straight plenum 30, a pipe 32, a curved duct take-off component 34, a floor boot 36, a wall stack 38, a reducer 40, a wall register 42, a wall register coupler 44, a floor register coupler 46, and plenum duct couplers 48. As a point of reference, FIG. 3 further illustrates an air source 50 in the form of a heat or furnace. Additionally, the duct work component(s) 10 can include components not specifically illustrated in FIG. 3 but commonly used as air handling system ductwork, such as tees, elbows, wyes, saddles, etc.

As should be evident from the above, the present disclosure is in no way limited to circular pipes. Instead, virtually any ductwork component is available with the present disclosure. In a preferred embodiment, all major ductwork of a particular air handling system is comprised of components provided in accordance with the present disclosure. The resultant air handling system can be entirely above ground, entirely below ground, or in combination thereof.

Although the present disclosure has been described with reference to preferred embodiments, workers skilled in the art will recognize that changes can be made in form and detail without departing from the spirit and scope of the present disclosure.

What is claimed is:

1. A rigid ductwork component for a residential, commercial, or industrial air handling system, the ductwork component comprising a rigid tubular, fire retardant layer including a foamed or non-foamed polymer resin and a fire retardant compound.
